(19) United States
(12) Patent Application Publication
(10) Pub. No.: US 2010/0150224 A1
(43) Pub. Date: Jun. 17, 2010

(54) METHOD AND DEVICE FOR CODING DATA IN A SCALABLE STREAM

(75) Inventors: Stéphane Pateux, Rennes (FR); Isabelle Amonou, Thorigne Fouillard (FR); Nathalie Cammas, Sens de Bretagne (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: France Telecom, Paris (FR)

(21) Appl. No.: 12/296,294

(22) PCT Filed: Apr. 6, 2007
(86) PCT No.: PCT/FR2007/051093

§ 371 Date: Jan. 28, 2009

(30) Foreign Application Priority Data
Apr. 7, 2006 (FR) 0651264

(51) Int. Cl. H04N 7/26

(52) U.S. Cl. 375/240.02; 375/E07.127

(57) ABSTRACT

The invention relates to a method of and a device for coding data in a scalable stream organized in units, characterized in that an indication is given in the header of an SVC NAL unit as to whether this NAL unit can be truncated or not in an adaptation operation for the scalable stream concerned

The invention relates to the coding, transmission and decoding of scalable video signals.

The invention proposes to improve the existing scalable video extraction and decoding algorithms, in particular the MPEG4-SVC algorithm, for decoding at a bit rate and a given spatial-temporal resolution.

More particularly, it is applicable in a scalable video coding context based on a multiple temporal decomposition with motion compensation and layered representation with inter-layer prediction.

Currently, most video coders generate a single compressed stream corresponding to all of the coded sequence. If several customers want to use the compressed file for decoding and display purposes, they must download (or “stream”) the complete compressed file.

Now, in a heterogeneous system (e.g. the Internet), not all clients have the same type of access to the data: the bandwidth, the processing capabilities and the screens of the customers' terminals can be very different. For example, in an Internet network, one of the customers may have an ADSL bit rate at 1024 kb/s and a powerful PC whereas the other has only modem access and a PDA.

One solution to this problem is to generate several compressed streams corresponding to different bit rates/resolutions of the video sequence: this solution is called “simulcast”. For example, one and the same video sequence can be coded twice to generate a stream A at 256 kb/s in QCIF resolution for the PDA and a stream B at 512 kb/s and super VGA resolution for the PC. With this solution, if the target is not a priori known (or if both types of targets are present on the network), the two streams A and B must be transported for a total bit rate of A+B (768 kb/s). It can therefore be seen that this solution is sub-optimal in terms of effectiveness of the representation since the same information (the information corresponding to the lower bit rate and resolution A stream) are coded several times (in the stream A and in the stream B). Furthermore, this method presupposes knowing in advance the characteristics of all the potential customers.

More recently, so-called scalable video coding algorithms have appeared, that is, algorithms with adaptable quality and variable spatial-temporal resolution, for which the coder generates a compressed stream in several layers, each of these layers being nested in the higher level layer. Thus, the stream A′ at 256 kb/s will be used in the preceding example for decoding the video for the PDA, but also for the PC, the higher resolution stream B′ at 512 kb/s being complementary to that. In other words, the bit rate needed to transport the two streams is in this case B′ (512 kb/s). This solution is more optimal in terms of effectiveness of the representation than the preceding solution.

The first generation of these scalable algorithms (see the work of MPEG-4, notably with the FGS—Fine Grain Scalability—type technologies) did not get established because of a compression sub-optimality: the scalable compressed stream (B′ in our example) is normally lesser in quality than the same non-scalable compressed stream (i.e., in our example: Q(B′)<Q(B)) for one and the same bit rate of 512 kb/s.

More recently, new algorithms have become established to respond to this effectiveness problem. They are currently being adopted by the MPEG standard, in the context of the MPEG4 work group.

Such coders are very useful for all the applications for which the generation of a single compressed stream, organized in several layers of scalability, can be used by several customers having terminals with different characteristics.

Notable among these are, for example:
VOD service (target terminals: UMTS, PC ADSL, TV ADSL, etc.),
session mobility (resumption on a PDA of a video session begun on TV; on a UMTS mobile of a session begun on GPRS),
session continuity (sharing bandwidth with a new application),
high-definition TV (single encoding to serve both SD—Standard Definition—customers and HD—High Definition—customers),
videoconferencing (single encoding for UMTS/Internet customers).

The MPEG JSVM model is described in the document “Joint Scalable Video Model JSVM-3”, J. Reichel, M. Wien, H. Schwarz, JVTP202, July 2005, Poznan.

The model that has been recently adopted by MPEG-4 SVC (“Scalable Video Coding”) is based on a scalable coder based on AVC (“Advanced Video Coding”) type solutions. It is a scalable video coder with inter-layer prediction and temporal decomposition by bidirectional prediction (images B). This new standard will be capable of supplying scalable streams with medium grain in the temporal and spatial dimensions and with quality.

The invention is an improvement of the JSVM coder/decoder according to the prior art.

The aim of the invention is to indicate simply, that is, using only the high-level information (i.e. information located in the headers of the NAL units), whether a quality-enhancing NAL unit is coded in progressive mode or not (i.e. can be truncated in an adaptation operation for a video stream).

In practice, it is possible to code the SNR quality enhancements according to two approaches: coding by progressive quantization (i.e., by using slice types called PR) or coding by successive quantization of the residues (i.e., by using slice types named EI, EP or EB).

The coding approach by progressive quantization offers the advantage of being able to truncate the NAL units coding this information and thus propose a gradual change to the SNR quality.

The second coding approach is less advantageous for a truncation operation, since it leads to a non-uniform quality enhancement in the picture.

It is important for a decoder or an extractor to know on what type of NAL unit it is working and whether or not it can apply a truncation. Currently, the type of coding for an SNR quality enhancement is signaled via the “slice_type” syntax element coded in the slice_header of the SVC NAL units. However, the information contained in the slice_header is difficult to read by a simple stream parser, since it is coded via variable-length code words. Only the high-level information (i.e., information accessible via the NAL unit headers) can be accessed simply by a parser.

The invention proposes a method of signaling the type of coding used for an SNR quality enhancement proposed by an SVC NAL unit. More specifically, an indication will be given for each NAL unit of this type as to whether it can be truncated or not.

This signaling of the coding type then makes it possible for a high-level parser having limited available processing power to be able to simply identify whether an information truncation mechanism can be applied to the NAL unit concerned.

The result is the insertion in the header information of an SVC NAL unit of a bit defining whether this NAL unit can be truncated or not.

According to a preferred characteristic, the indication of the truncation of an SVC NAL unit is produced using the bit associated with the “reserved_bit” syntax element available in the SVC NAL unit header.

According to another preferred characteristic, the truncation marking is not directly linked to the type of slice used.

The invention also relates to a device for coding data in a scalable stream organized in units,

characterized in that it comprises means for indicating in the header of an SVC NAL unit whether this NAL unit can be truncated or not in an adaptation operation for the scalable stream concerned.

The invention also relates to a computer program product comprising program instructions for executing the preceding coding method.

The invention also relates to a signal comprising data in a scalable stream organized in units, characterized in that it comprises information in the header of an SVC NAL unit to indicate whether this NAL unit can be truncated or not in an adaptation operation for the scalable stream concerned.

Other characteristics and advantages of the invention will become apparent from the description that follows, given in light of the appended drawings in which:

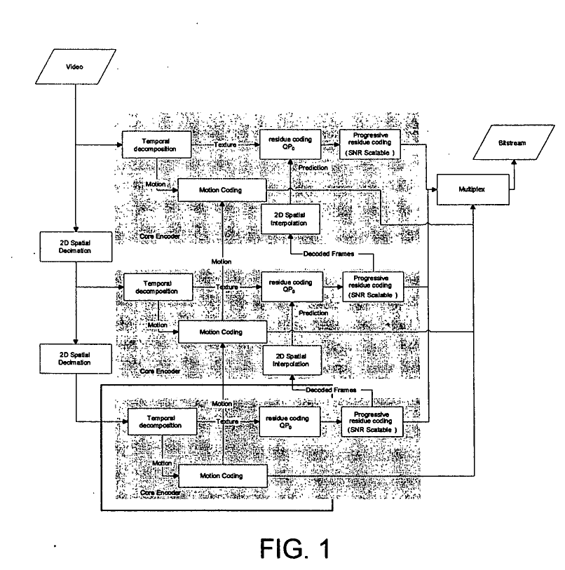

FIG. 1 represents a scalable coder based on AVC-type solutions,

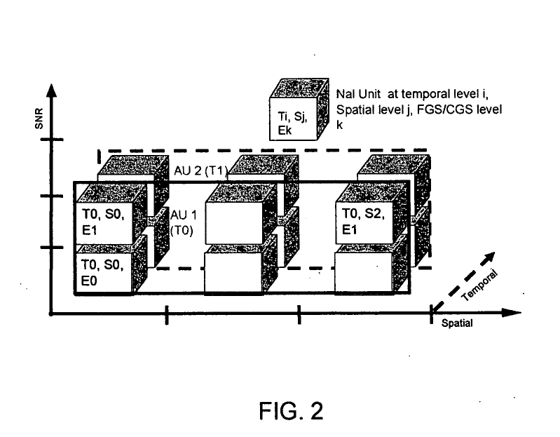

FIG. 2 represents the general structure of the SVC stream,

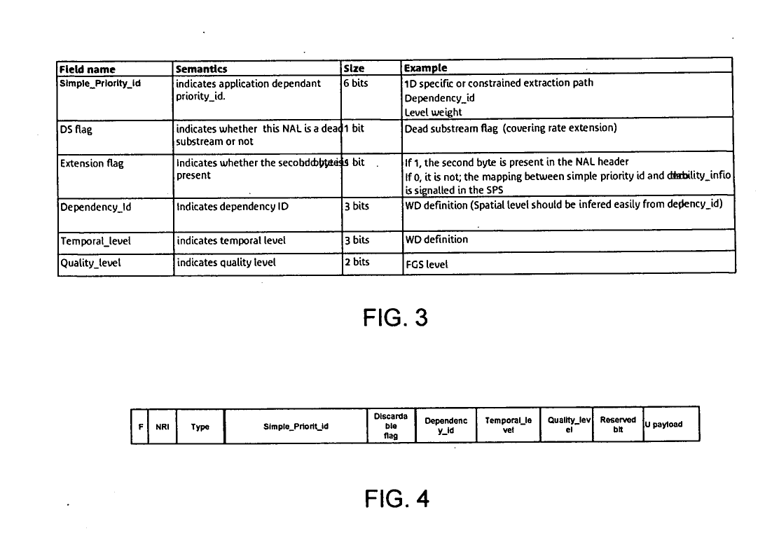

FIG. 3 represents the format of the NAL unit headers in the current SVC version,

FIG. 4 represents a variant of the SVC NAL unit headers,

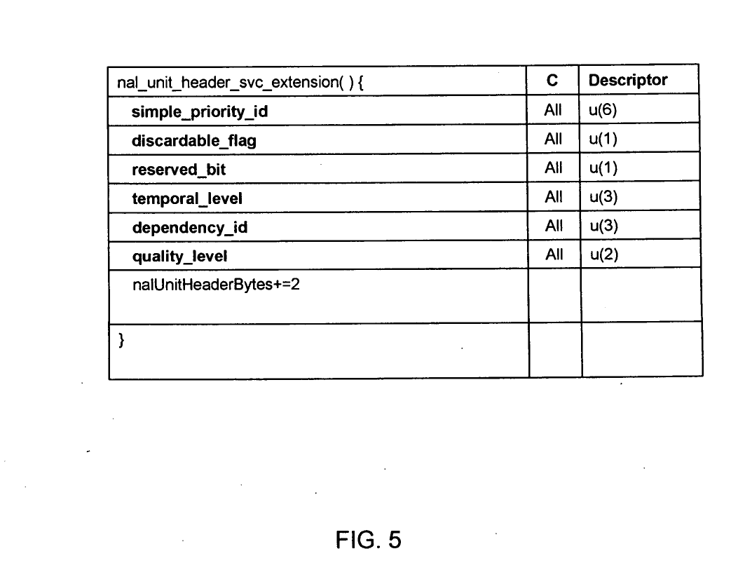

FIG. 5 illustrates the syntax associated with a header of an SVC NAL unit,

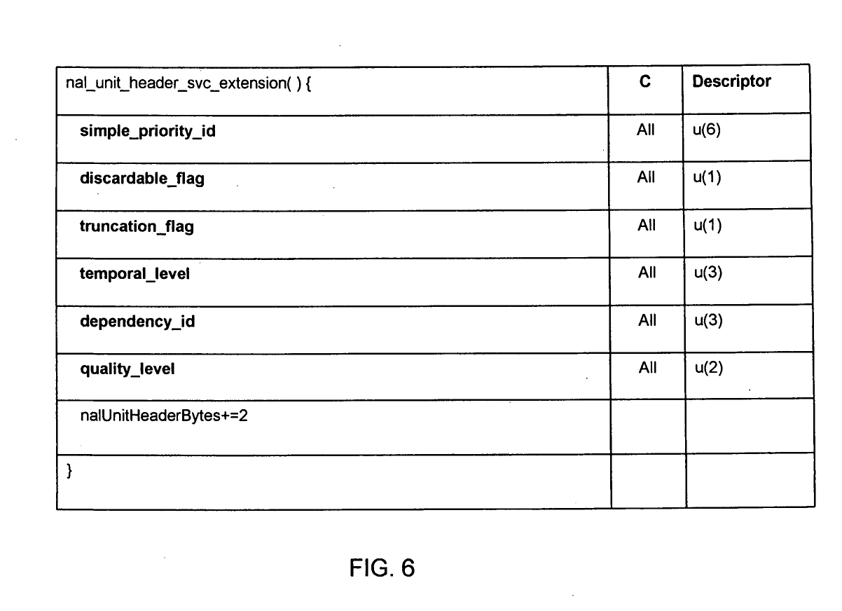

FIG. 6 illustrates the syntax associated with a header of an SVC NAL unit according to the invention.

The scalable coder based on an AVC-type solution is diagrammatically represented in FIG. 1.

The main characteristics of this coder are as follows:
pyramidal solution with dyadic under-sampling of the input components;
temporal decomposition by B images at each level;
coding of the successive layers in CGS mode or in FGS mode.

The coding by progressive quantization FGS mode is characterized by:
Coding of a low-resolution version of the video sequence up to a given bit rate R_r0_max which corresponds to the maximum decodable bit rate for the low spatial resolution r0 (this base level is AVC compatible).
Coding of the higher levels by subtraction of the reconstructed and over-sampled preceding level and coding of the residues in the form:
   Of a base level
   Of one or more enhancement levels obtained by multiple-pass coding of bit planes (hereinafter: FGS). The prediction residue is coded up to a bit rate R_ri_max which corresponds to the maximum decodable bit rate for the resolution ri.

The progressive coding technique used in the JSVM is progressive quantization. This technique involves quantizing the various coefficients with a first rough quantization pitch. Then, the various coefficients are reconstructed and the difference between the value of the coefficient and the quantized value is calculated. This difference is then quantized with a second, finer quantization pitch. This process is repeated with a certain number of quantization pitches.

At each quantization pitch, the quantized coefficients are coded in two passes:
a meaning pass which codes the new meaningful coefficients, those that have not been coded with the preceding quantization pitch For these new coefficients, the sign of the coefficient and its value are coded;
a refinement pass which refines/codes the coefficients that were already meaningful in the preceding quantization pitch. For these coefficients, the refinement value +1 or −1 is coded.

In this progressive coding mode, the coefficients are in addition scanned in a particular order through the constituent blocks of an image in order that, on truncation of the information packet attached to this SNR quality enhancement, the quality increment is fairly well distributed over the image.

To do this, the coding of the coefficients is done in several passes on the different blocks forming an image; on each coding pass, only a limited number of coefficients is coded for each block.

This type of NAL unit can be truncated before decoding.

The CGS (layered coding) mode is characterized by:
Base level coded with a quality 0 (layer 0, avc QP0);
Enhancement levels coded with a superior quality (QPi);
Refinement of the texture and motion information;
Difference between the layers and entropic coding.

This type of NAL unit cannot be truncated before decoding.

The syntax of the SVC stream will now be detailed.

The general structure is described with reference to FIG. 2. The SVC stream is organized in access units (AUs), each corresponding to an instant and comprising one or several access units for the network (packet) or NALUs (Network Abstraction Layer Units).

Each NALU, or NAL unit, is associated with an image derived from the spatial-temporal decomposition, a spatial resolution level, and a coding quality level. This NALU structure makes it possible to produce a bit-rate adaptation and/or spatial-temporal resolution by eliminating the excessively high spatial resolution NALUs, or excessively high temporal frequency NALUs, or even excessively high coding quality NALUs.

Each NALU encapsulates an image slice. A slice is a set of macroblocks contained in an image.

The format of the NAL unit headers in the current SVC version is now described with reference to FIG. 3.

Each SVC-specific NAL unit (type 20 or type 21 NAL unit) comprises an AVC header byte (NAL unit type byte) and one or two SVC header bytes containing the fields (P, D, T, Q) (Priority_id, Dependency_id, Temporal_level, Quality_level).

These fields can be used to produce a spatial resolution and/or temporal frequency and/or quality adaptation, by retaining only the NAL units that have a sufficiently high field level (P, D, T, Q).

The Priority_id field indicates a priority level of an NAL unit that can be used to guide a quality adaptation.

The Dependency_id field makes it possible to know the spatial resolution level of a coding hierarchical layer. This level can also control an SNR quality enhancement level or temporal enhancement level in the context of a layered coding (i.e. for a discrete number of operating points).

The Temporal_level field makes it possible to indicate the temporal level indicating the image frequency.

The Quality_level field makes it possible to indicate the progressive quantization level, and therefore control the bit rate/quality and/or the complexity.

With reference to FIG. 4, the SVC NAL unit headers are made uniform and there are still two SVC header bytes. The bit associated with the “extension flag” syntax element has therefore been converted into the “reserved_bit” syntax element which corresponds to a bit that is not defined but reserved for a possible future use.

We will now consider the format of the slice headers in the current SVC version.

A slice is a set of macroblocks contained in an image. There can be several slices in an image (typically, to limit the size of the NAL units, limit the impact of a packet loss, produce an adaptive coding for each image region, and so on).

Each slice is encapsulated in an NALU. In SVC, the SNR quality enhancement information is coded in the type 20 or 21 NAL units that have a non-zero “quality_level” and use the following “slice_types”:
PR: slice coded in progressive refinement mode;
EI, EP or EB: slice coded in non-progressive refinement mode (enhanced I, P, B picture).

It is possible to code an SNR quality enhancement via the use of a non-progressive type coding. This approach is motivated by the fact that SVC coding is easier to implement (implementing a progressive coding is relatively difficult), yet offers a medium-grain scalability (i.e., in pitches of the order of 10%) in bit rate.

FIG. 5 illustrates the header of an SVC NAL unit which is defined by the following syntax:
the “simple_priority_id” field, coded on 6 bits, makes it possible to signal priority information for the NAL unit concerned. This priority information can be used by an adaptation tool for the video stream when producing a video stream adaptation (for example, by retaining only the NAL units that have a sufficient priority level).
the discardable_flag field, coded on one bit, indicates whether the NAL unit concerned is useful in the inter-layer coding (or inter-layer prediction to use the SVC terminology) of a higher layer (for example, corresponding to a higher spatial resolution level).
the reserved_bit field, coded on one bit, is not used and is reserved for a possible future use.
the temporal_level field, coded on 3 bits, indicates the temporal level associated with the NAL unit concerned.
the dependency_id field, coded on 3 bits, indicates the coding layer index to which the NAL unit concerned contributes. The notion of coding layer can correspond to the different spatial resolution levels in a resolution scalability, but also to the different SNR quality (even temporal) layers in a layered coding.
the quality_level field, coded on 2 bits, corresponds to the coded SNR quality enhancement level within a layer (dependency_id).

In order to signal whether an NAL unit can be truncated or not, the invention then proposes, in a particular embodiment, to reassign the available reserved_bit.

The syntax associated with a header of an SVC NAL unit according to the invention is then defined with reference to FIG. 6.

According to the invention, the indication of possibility of truncation of an SVC NAL unit is produced by using the bit associated with the “reserved_bit” syntax element available in the SVC NAL unit header. This field is renamed “truncation_flag”:
if the value of the truncation_flag field is 1, then the NAL unit concerned can be truncated in an adaptation operation for the video stream;
if the value of the truncation_flag field is 0, then the NAL unit concerned cannot be truncated in an adaptation operation for the video stream.

In a particular application, the invention proposes not to directly link the marking of the truncation possibility to the slice type used. In SVC, the following cases are considered:

an NAL unit corresponding to a PR type slice can be truncated;
an NAL unit corresponding to an EI, EP or EB type slice cannot be truncated.

Thus, it may be necessary using the invention to signal that an NAL unit coded in non-progressive mode can be truncated or even that an NAL unit coded in progressive mode cannot be cut.

Useful indications for controlling the authorized adaptations are given below by way of example:
cut an NAL unit coded in non-progressive mode if it is too long,
do not allow an NAL unit coded in progressive mode to be truncated because it is too small, or even because the application context concerned does not take account of NAL unit truncation.

As a variant, this additional bit is inserted into an additional NAL unit in the AU.

1. A method of coding data in a scalable stream organized in units, wherein an indication is given in the header of an SVC NAL unit as to whether this NAL unit can be truncated or not in an adaptation operation for the scalable stream concerned.

2. The coding method as claimed in claim 1, wherein the indication of the truncation of an SVC NAL unit is produced using the bit associated with the “reserved bit” syntax element available in the SVC NAL unit header.

3. The coding method as claimed in claim 1, wherein the truncation marking is not directly linked to the type of slice used.

4. A device for coding data in a scalable stream organized in units, wherein it comprises means for indicating in the header of an SVC NAL unit whether this NAL unit can be truncated or not in an adaptation operation for the scalable stream concerned.

5. A computer program product comprising program instructions for executing the coding method as claimed in claim 1.

6. A signal comprising data in a scalable stream organized in units, wherein it comprises information in the header of an SVC NAL unit to indicate whether this NAL unit can be truncated or not in an adaptation operation for the scalable stream concerned.
